(19) United States
(12) Patent Application Publication
(10) Pub. No.: US 2010/0249965 A1
(43) Pub. Date: Sep. 30, 2010

(54) Integrated Blood Glucose Measurement Device

(75) Inventors: Anoop Rao, Cambridge, MA (US); Sonny Vu, Salem, NH (US); Timothy Golnik, Boxford, MA (US)

Correspondence Address: Larson & Anderson, LLC, P.O. BOX 4928, DILLON, CO, 80435, US

(73) Assignee: AGAMATRIX, INC., Salem, NH (US)

(21) Appl. No.: 12/749,707

(22) Filed: Mar. 30, 2010

Related U.S. Application Data
(60) Provisional application No. 61/165,341, filed on Mar. 31, 2009.

(51) Int. Cl. G06F 17/00

(52) U.S. Cl. 700/94

(57) ABSTRACT

The present invention provides a method of transferring data between a diagnostic measurement device and a portable consumer electronic device (CED). The method includes a step of communicatively coupling the diagnostic measurement device and the CED through an audio port located on the CED. The method also includes the step of transferring data from the diagnostic measurement device to the CED through the audio port of the consumer electronic device.

### CROSS-REFERENCE TO RELATED APPLICATIONS

This application is a non-provisional application of and claims the benefit of U.S. Provisional Application Ser. No. 61/165,341, filed on Mar. 31, 2009 which is incorporated herein by reference for all purposes. This application is related to U.S. Provisional Patent Application Ser. No. 61/078,740 filed on Jul. 7, 2008 and U.S. application Ser. No. 12/498,227 filed on Jul. 6, 2009 which are incorporated herein by reference for all purposes.

### BACKGROUND

The use of portable consumer electronic devices (CED) has allowed users of such devices the ability to carry computing power with them and in the case of web-enabled CEDs has allowed them to have access the world wide web in remote locations. CEDs include hand-held devices such as music storage devices (e.g. IPOD™, MP3 players, and similar devices), cell phones (e.g. an IPHONE™, a BLACKBERRY™, TREO™, and similar devices) and personal data assistants and web access assistants (e.g. the ITOUCH™, ITABLET™, and similar devices). Web-enabled devices allow users to connect to the world wide web (WWW) via wireless technology through wireless local area networks and/or through cell phone networks and towers, such as the EDGE™ and 3G™ networks, provided by AT&T. A user can download information as well as upload information to the WWW using these devices.

A user of these CEDs may have some physical impairment or ailment which may require periodic checks (e.g. once an hour or several times a day, week, and/or month) to determine whether a personal physiological characteristic is nearing or has reached a threshold level where physical danger is approaching or has approached. One example of such a user is a diabetic patient whom may be required to test for the concentration of glucose within their blood stream several times a day. This diabetic user typically carries on their person lancets for piercing their skin to acquire a blood sample, a blood glucose meter (BGM), and disposable diagnostic test strips (e.g. disposable test strips having a working and counter electrode in connection with a measurement space) to which they apply the blood samples and insert into the blood glucose meter for analysis.

Much work has been done to make the analysis procedure for impaired patients as convenient and painless as possible. It would be extremely desirable to incorporate a diagnostic testing apparatus with a CED where possible. However there still is a need to integrate these devices and to overcome the processing and data storage requirements of programs offering complex calculations, such as diagnostic tests (e.g. those for complicated tests such as the concentration measurement of glucose in blood). Furthermore, many manufacturers of CEDs actively block data transfer/sharing using the data transfer connection ports on the CED to/from externally operated devices, such as a BGM. The present invention solves the problems of the prior are and provides a combined diagnostic device (e.g. BGM) and CED and provides a method of transferring data between the devices.

### SUMMARY OF INVENTION

In one embodiment, the present invention provides a combination comprising a blood glucose meter (BGM) communicatively coupled to a web-enabled portable consumer electronic device (CED) through an audio port of the CED. Data is transferred between the BGM and the CED through the audio port of the CED. The audio port is selected from the group consisting of an audio port pin on a multi-pin connector of the CED, a headphone audio port of the CED, and a microphone audio port of the CED. The BGM has a test strip opening sized to receive an electrochemical test strip.

In a second embodiment, the present invention provides a method of transferring data between a diagnostic measurement device and a portable consumer electronic device (CED). The method includes a step of communicatively coupling the diagnostic measurement device and the CED through an audio port located on the CED. The method also includes the step of transferring data from the diagnostic measurement device to the CED through the audio port of the consumer electronic device.

### BRIEF DESCRIPTION OF THE DRAWINGS

FIG. 1 is a front view of an ITOUCH™.

FIG. 2 is a front view of an ITOUCH™ connected to a BGM.

FIG. 3 is a front view of an ITOUCH™ connected to a BGM.

FIG. 4 is a front view of an ITOUCH™ connected to a external battery pack which is in turn connected to a BGM.

### DETAILED DESCRIPTION OF THE INVENTION

Reference throughout the specification to “one embodiment,” “another embodiment,” “an embodiment,” “some embodiments,” and so forth, means that a particular element (e.g., feature, structure, property, and/or characteristic) described in connection with the embodiment is included in at least one embodiment described herein, and may or may not be present in other embodiments. In addition, it is to be understood that the described element(s) may be combined in any suitable manner in the various embodiments.

The use of a CED in combination with a diagnostic measurement device such as an analyte meter (e.g. blood glucose meter (BGM)) is provided. The diagnostic measurement device of the present invention is not limited and in one embodiment is preferably an analyte meter (e.g. a blood glucose meter) of the type that described in US patent publication number US 2005/0265094, herein incorporated by reference. Throughout the remaining text the diagnostic measurement device will be described within the context of an exemplary embodiment where the diagnostic measurement device is an analyte measurement device that measures the concentration of glucose within a blood sample (e.g. a BGM).

The CED of the present invention is not particularly limited other than the CED has an audio data transfer port. In a preferred embodiment the CED is a product having a 30 pin data/power transfer connector (e.g. an IPOD™, IPHONE™, ITOUCH™, or ITABLET™) and/or a microphone and/or a headphone audio output port. Throughout the following text the CED will be described within the context of an exemplary embodiment where the CED has a 30 pin data/power transfer connector and a headphone audio port (e.g. where the CED is an IPOD™ or ITOUCH™). Applicants note that an IPHONE™ is similar to these two devices but it further comprises a microphone audio port, inter alia. One embodiment described below is specifically designed for audio data transfer between an IPHONE™ and a BGM.

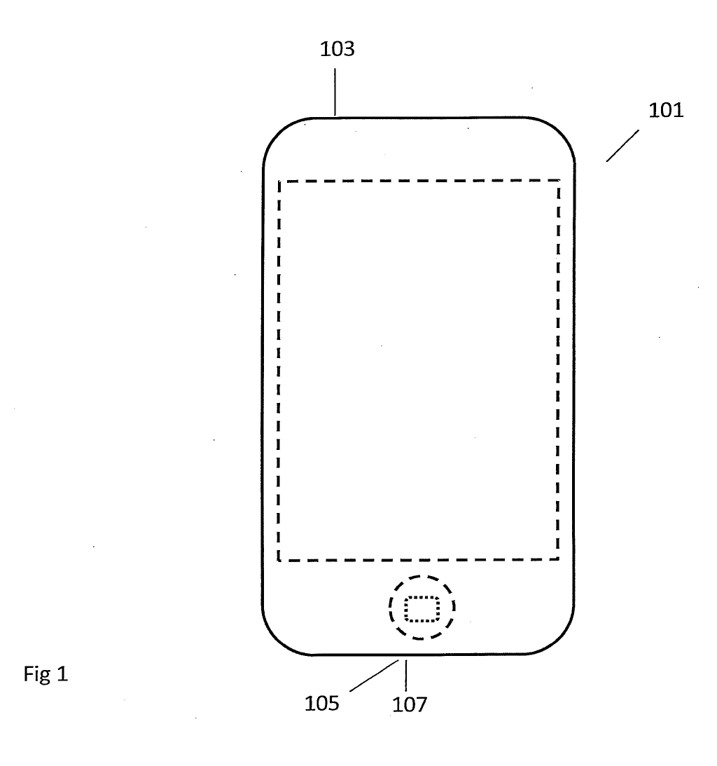

A BGM calculates the concentration of glucose in a blood sample applied to a disposable electrochemical test strip inserted in the meter. The BGM then can display the calculated value to the user and/or can transmit the data to a separate device. The present invention provides for the transmission of data calculated by the BGM to a CED for use by the CED and for display to a user. Data transfer between the BGM and the CED of the present invention occurs, at least in part, through an audio port of the CED. As shown in FIG. 1 a CED 101 (e.g. an IPOD™ or ITOUCH™) has at least 3 audio ports 103 (e.g. headphone audio port), 105 (left audio in pin port), and 107 (right audio in pin port).

Data transfer between the BGM and the CED is modulated/demodulated by a modem-type connection where data from/to the BGM and CED is modulated to a carrier signal, carried by the signal, and then demodulated to receive the data. In the case of an IPHONE™ there is also a microphone port (not shown in FIG. 1) and data transfer can also occur through this port if present. Data transfer in this embodiment, for example from the BGM to the CED, occurs by modulating data to sound signal using a speaker in the BGM, receiving the sound in the microphone of the CED, and demodulating the sound signal to provide data within the CED. Data transfer from the CED to the BGM would occur by modulating data from the CED to a sound signal using a speaker in the CED, receiving sound at a micorphone in the BGM, and demodulating data from the sound signal to data in the BGM.

The CED comprises a program that receives information from the BGM and displays characteristics regarding the information to a user using the display of the CED. The program may come resident on the CED from the manufacturer or it may be downloaded after purchase for example from an application store (e.g. The “app” store). The CED may also intake, store, and/or calculate and provide information relating to previous tests, characteristics about the user (e.g. height, weight, age, etc.), characteristics about future tests, and/or characteristics about suggested medication intake or physical exercise. For Example, U.S. Pat. Nos. 5,897,493 and 6,602,191 which are incorporated herein by reference disclose health management systems that can intake information relating to numerous characteristics of a user. The CED may use this information to determine a suggested insulin dosage for a user or other parameters. In other embodiments, the CED may receive input from a variety of sensors (e.g. temperature sensors, accelerometers, altimeters, inter alia) to interpret or provide for regional corrections of the electrochemical test performed by the BGMs. As is already known, BGM results can be affected by several environmental parameters such as temperature, altitude, and humidity etc.

In one embodiment the BGM calculates a glucose concentration level and transfers this data through a modulating/demodulating modem connection to the CED using a carrier signal. When received by the CED the conveyed data can, inter alia, be stored, displayed as a value, or can initiate a program (e.g. a game), play an audio file and or display an image in response to the result. The data conveyed by the BGM can include, inter alia, information about the a test result, information about strip usage pattern, strip/meter coding, errors during measurement.

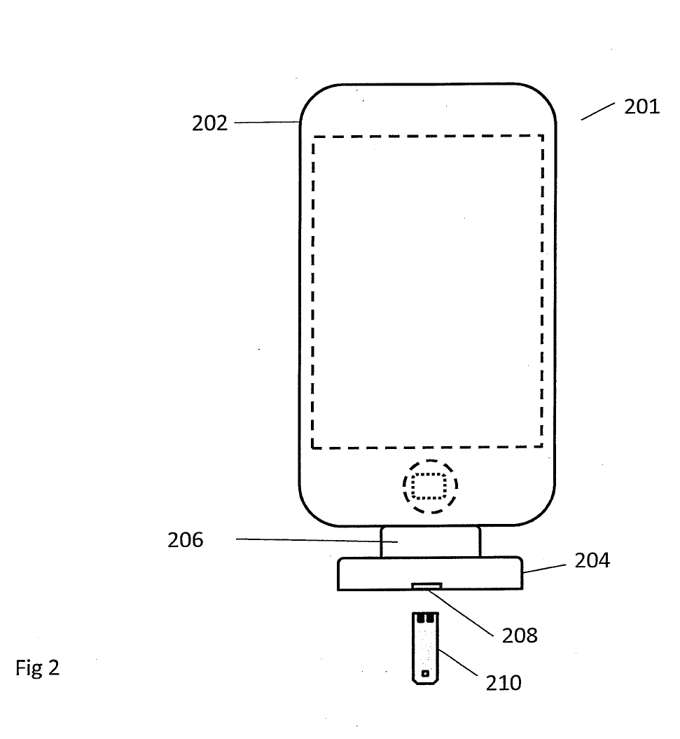

FIG. 2 shows a combined BGM/CED 201 including both a CED 202 and a BGM 204 in accordance with one embodiment of the present invention. The BGM 204 is communicatively connected to CED 202 through a modem connection 206 to the either or both of the left and/or right audio in ports (not shown) of the 30 pin connector of the CED. The BGM 204 has a strip port 208 adapted to receive a disposable electrochemical test strip 210. The test strips are not particularly limited. As a non-limiting example, test strips that are suitable for use with the embodiments of the present invention are disclosed in U.S. Ser. No. 10/908,656, which is herein incorporated by reference. In the embodiments described herein and that shown in FIG. 2, the BGM may comprise its own power source for powering the BGM and/or it can be connected to the power source of the CED. In the present embodiment, the BGM is connected to the power source of the CED through one or more pins provided in the 30 pin port of the CED. Where both the BGM comprises its own power source and it is connected to the power source of the CED the power draw scheme for powering the BGM is preferably drawn from the CED first and from the BGM second, to preserve backup power of the BGM should the CED be depleted of power.

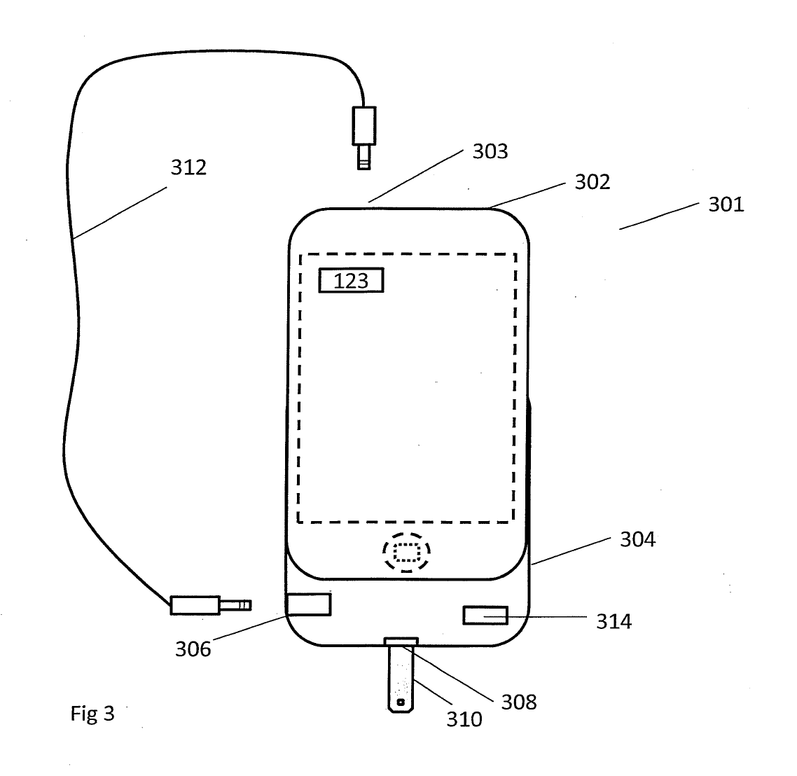

FIG. 3 shows a combined BGM/CED 301 including both a CED 302 and a BGM 304. The BGM 304 is communicatively connected to CED 302 through a modem connection 306 to the headphone audio port 303 of the CED 302 using signal wire 312 (shown not in ports). A disposable electrochemical test strip 310 is inserted into strip port 308.

The BGM portion of the combined devices described herein may optionally comprise a display 314 (e.g. a light-emitting diode LED, a liquid crystal display LCD, or a similar display) for displaying information to a user regarding testing, information about the calculated result, information regarding the disposable test strip or the meter, and among other information.

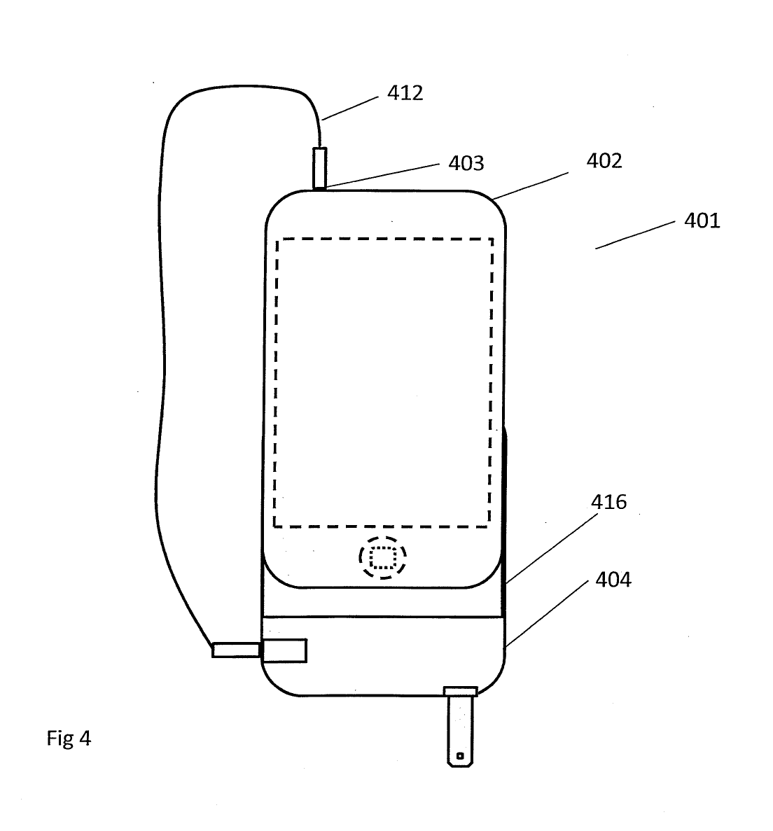

FIG. 4 shows a combined BGM/CED/External Power Source (EPS) 401 similar to that shown and described in U.S. Provisional Patent Application Ser. No. 61/078,740 filed on Jul. 7, 2008 which is incorporated herein by reference for all purposes. Here BGM 404 is connected to CED 402 by signal wire 412 through the headphone port 403 of the CED 402. The combined device 401 further comprises an external battery pack 416 to provide supplemental power to the combination 401.

In a further embodiment, the BGM is connected to the CED via the 30 pin connector to draw power from the CED but the BGM communicates wirelessly with the CED to convey data with the CED.

In certain embodiments the present invention provides a combined BGM device and CED device, where data transfer between the devices occurs through an audio port of the CED. It is preferred that the data transfer and communication is accomplished via a modem-type connection which modulates data from one device to a carrier signal that is transferred between the devices and demodulates the data from the carrier signal for use by the other device. The combined devices described above provide the following additional benefits:

A. A successful diagnostic test strip insertion into the BGM queries whether the BGM is communicatively connected to the CED. Detection of strip insertion can be accomplished by the strip insertion closing a circuit or by shorting two contacts resulting in a change in the resistance of an already closed circuit. Insertion detection is described in U.S. Pat. Nos. 4,627,445, 4,714,874, 4,999,582, 5,108,564, 5,266,179, 5,282,950, 5,320,732, 5,352,351, 5,438,271, 5,526,120, and 5,593,390, all of which are incorporated herein by reference for all purposes.

B. If the BGM is communicatively coupled to the CED then the strip insertion can initiate a program on the CED.

C. Data transfer between the BGM and the CED in either direction occurs through an audio port of the CED.

D. Information regarding a user, test results, and the like can be displayed to a user on the display of the CED or on the display of the LCD and on a display of the BGM.

E. Information regarding a user, test results, and the like can be stored on the CED, the BGM, or on both the CED and BGM.

F. Where the CED is a web-enabled device information regarding a user, test results, and the like can be transmitted from the CED to a remote location using the web-enabled ability of the device.

1. A method of transferring data between a diagnostic measurement device and a portable consumer electronic device (CED), the method comprising the steps of:
(i) communicatively coupling the diagnostic measurement device and the CED through an audio port located on the CED; and
(ii) transferring data from the diagnostic measurement device to the CED through the audio port of the consumer electronic device.

2. The method of claim 1, where the diagnostic measurement device is a blood glucose meter (BGM), wherein the BGM has a test strip opening size to receive an electrochemical test strip.

3. The method of claim 2, wherein upon a successful insertion of an electrochemical test strip into the test strip opening of the BGM, the BGM queries whether the BGM is communicatively connected to the CED.

4. The method of claim 2, wherein upon a successful insertion of an electrochemical test strip into the test strip opening of the BGM, the CED initiates a program.

5. The method of claim 2, wherein the data transferred from the BGM to the CED is data regarding a user or test results calculated by the BGM.

6. The method of claim 2, wherein the CED is a web-enabled CED wherein data transferred from the BGM to the CED is transmitted from the CED to a remote location using the web-enabled ability of the CED.

7. The method of claim 2, wherein the CED comprises,
a sensor to sense and provide supplemental data,
a program to compile the data received by the BGM and the supplemental data and to make calculations using the data received by the BGM and the supplemental data, and
a display for displaying the results of the calculations.

8. The method of claim 1, wherein the CED has a multi-pin connector comprising a first audio port pin located in the multi-pin connector, wherein data is transferred in step (ii) through the first audio port pin.

9. The method of claim 8, wherein the multi-pin connector has a second audio port pin, wherein data is transferred in step (ii) through the second audio port pin.

10. The method of claim 8, wherein the multi-pin connector has a external device power supply pin, wherein the diagnostic measurement device draws power from the power supply pin.

11. The method of claim 1, wherein the CED has a microphone audio port, wherein data is transferred in step (ii) through the microphone audio port.

12. The method of claim 1, wherein the CED has a headphone audio port, wherein data is transferred in step (ii) through the headphone audio port.

13. The method of claim 1, wherein data is transferred in step (ii) using a modem connection which modulates data from the diagnostic measurement device to a carrier signal that is transferred to the CED which demodulates the data from the carrier signal for use by the CED.

14. The method of claim 1, where data is transferred in step (ii) as a sound file.

15. The method of claim 1, wherein the method further comprises the step of:
(iii) transferring data from the CED to the diagnostic measurement device through the audio port of the CED.

16. The method of claim 15, wherein data is transferred in steps (ii) and (iii) using a modem connection which modulates data from one device to a carrier signal that is transferred between the devices and demodulates the data from the carrier signal for use by the other device.

17. The method of claim 15, wherein data is transferred in steps (ii) and (iii) as sound files.

18. The method of claim 1, wherein the consumer electronic device is a web-enabled CED.

19. The method of claim 1, wherein the CED has a multi-pin connector comprising an external device power supply pin, wherein the diagnostic measurement device draws power from the power supply pin.

20. The method of claim 19, wherein the CED has a headphone audio port, a microphone audio port, or both a headphone port and a microphone audio port wherein data is transferred in step (ii) through the headphone audio port, the microphone audio port, or both the headphone port and the microphone audio port.

21. The method of claim 1, further comprising the step of:
electrically coupling the diagnostic measurement device to an external battery supply and to a power supply of the CED, where operating power for the diagnostic measurement device is drawn first from the external battery supply, then from the power supply of the CED, and then lastly from the diagnostic measurement device.

22. A combination comprising:
a blood glucose meter (BGM) communicatively coupled to a web-enabled portable consumer electronic device (CED) through an audio port of the CED, wherein:
data is transferred between the BGM and the CED through the audio port of the CED,
the audio port is selected from the group consisting of an audio port pin on a multi-pin connector of the CED, a headphone audio port of the CED, and a microphone audio port of the CED, and
the BGM has a test strip opening sized to receive an electrochemical test strip.

23. The combination of claim 21, further comprising an external battery supply wherein the BGM is electrically coupled to a power supply of the CED and to the external battery supply.
